(19) United States
(12) Patent Application Publication
(10) Pub. No.: US 2008/0047183 A1
(43) Pub. Date: Feb. 28, 2008

(54) Advertising device for crowd guiding systems

(76) Inventor: Gustavo Rodriguez-Aparicio, Guaynabo, PR (US)

Correspondence Address: Gustavo Rodriguez-Aparicio;Ed. Centro Intl. de, Mercadeo, Torre 1, Of, 503. Carr. 165 # 100, Guaynabo, PR, 00968, US

(21) Appl. No.: 11/703,456

(22) Filed: Feb. 8, 2007

Related U.S. Application Data
(60) Provisional application No. 60/772,955, filed on Feb. 15, 2006.

(51) Int. Cl. G09F 17/00

(52) U.S. Cl. 40/603

(57) ABSTRACT

A device for advertising, display of information, personalized messages, and the like, which can be mechanically attached to a crowd guiding system, such as post and retractable belts. A flexible wall section contains displayed information, and can form three dimensional images. The wall section is removable so that other information may be displayed on the device.

### CROSS REFERENCE TO RELATED APPLICATIONS

NONE

### FEDERALLY SPONSORED RESEARCH

NONE

### SEQUENCE LISTING

NONE

### DESCRIPTION

1. Field of the Invention

The present invention relates to an advertising device for crowd guiding systems, and more particularly to a display device adapted to have advertising images disposed thereon and which can be readily affixed to crowd guiding systems, such as post with extensible belts or velvet tubes.

2. Description

The posts for crowd control are located in high traffic areas. With our device, mini-billboards that hang either from the posts or envelope the extensible tape between the posts, these areas are customized with advertisers' logos and messages. These mini-billboards envelope the public, which enters the universe of the advertising campaign.

People in line do not usually have anything on which to focus their attention, which leads the new media to always be noticed, reaching a level of dispersion next to zero.

And the display time for messages at a short distance is certainly greater than the other media channels.

Messages may suggest methods of payment, additional services or even direct purchasing of merchandise displayed at the end or along the line by means of shelves attached to the posts. Contrary to the large panels that dominate the urban landscape and the interior of establishments, our new media is subtle.

But it has a high impact capacity, because it is spread over large areas and the public interact with it in its own sphere of action, where messages are repeated.

You are about to go into a movie theater. We take debit cards here, why not use yours? How about a new brand of candy to go with your movie? With questions such as the ones above just before the point of sale we encourage patrons to increase consumption, creating the perfect call to action.

Our device has no adverse effects. The mini-billboards are a part of the separation posts that are already there, so they do not interfere with the functionality of the equipment and maintain a pleasant environment.

In addition the advertiser leaves the impression of caring about the order of that space since the media mini-billboards are part of an organization system.

### BRIEF DESCRIPTION OF THE DRAWINGS

IN ORDER THAT THE INVENTION MAY BE MORE FULLY UNDERSTOOD, IT WILL NOW BE DESCRIBED, BY WAY OF EXAMPLE, WITH REFERENCE TO THE ACCOMPANYING DRAWING IN WHICH:

FIG. 1 IS A PICTORIAL REPRESENTATION OF A FLAT DISPLAY DEVICE, ACCORDING TO THE PRINCIPALS OF THE CURRENT INVENTION, AFFIXED TO A CROWD GUIDING SYSTEM COMPOSSED BY BELTS AND POSTS;

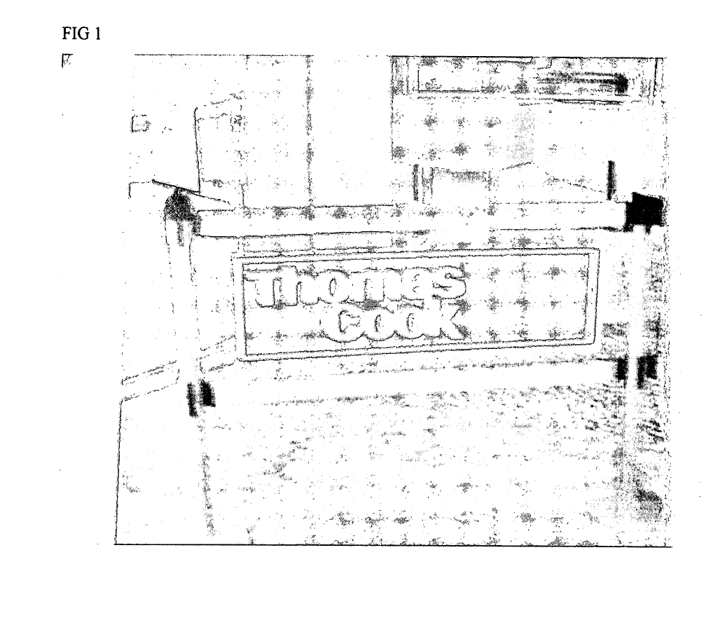

FIG. 2 IS A PICTORIAL REPRESENTATION OF A FLAT DISPLAY DEVICE, ACCORDING TO THE PRINCIPALS OF THE CURRENT INVENTION, AFFIXED TO A CROWD GUIDING SYSTEM COMPOSSED BY POSTS, AND WHERE THE INVENTION ITSELF REPLACES THE FUNCTIONAL VALUE OF THE BELTS;

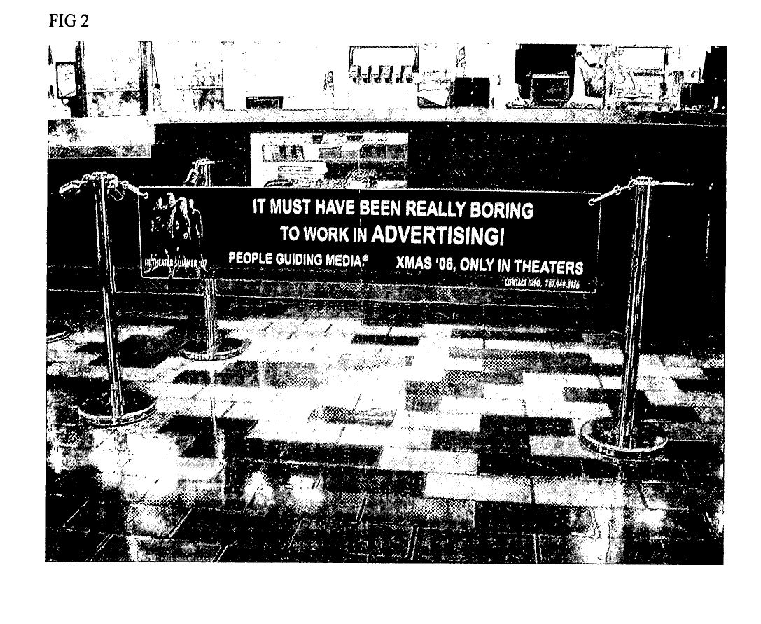

FIG. 3 IS A PICTORIAL REPRESENTATION OF A DISPLAY DEVICE, ACCORDING TO THE PRINCIPALS OF THE CURRENT INVENTION, WHERE ADVERTISING MESSAGES ARE PRINTED ON THE CROWD GUIDING SYSTEM'S BELT.

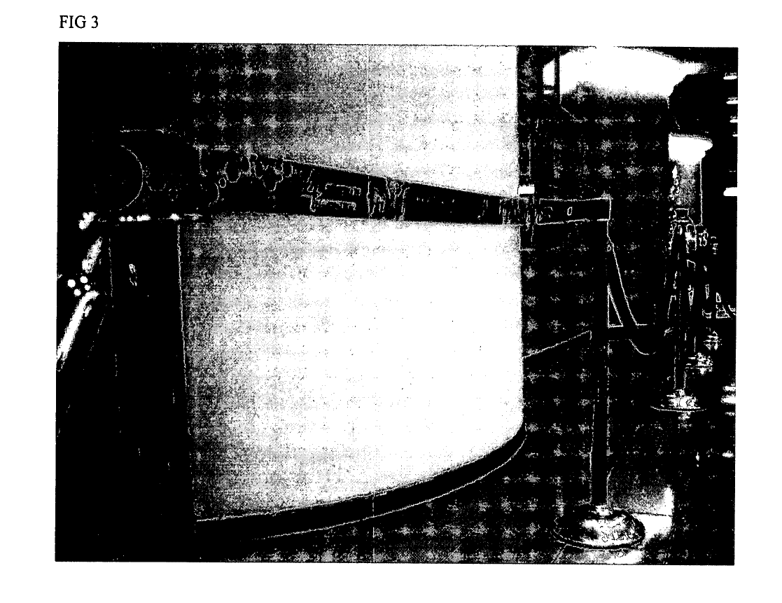

FIG. 4 IS A PICTORIAL REPRESENTATION OF A DISPLAY DEVICE, ACCORDING TO THE PRINCIPALS OF THE CURRENT INVENTION, WHERE ADVERTISING MESSAGES ARE PRINTED ON THE CROWD GUIDING SYSTEM'S UPPER AND LOWER BELTS.

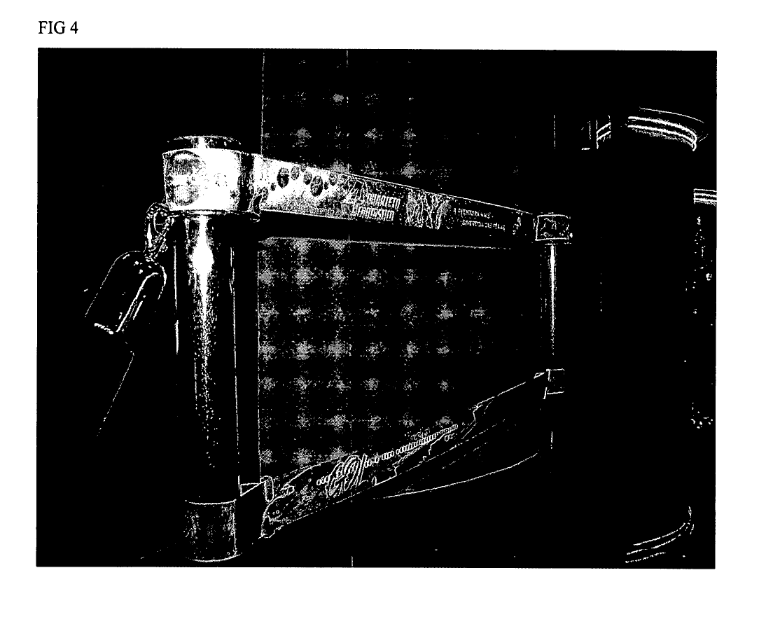

Having thus set forth the nature of the invention what is claimed is:

1. A display device for use on crowd guiding systems, consisting on a two dimensional (flat) device that hangs either between two adjacent posts or from the extensible belt that links two adjacent posts.

2. A display device according to claim 1, wherein said two dimensional material includes means for affixing or printing advertising indicia thereon.

3. A display device according to claim 1, wherein said sheet material is transparent.

4. A display device according to claim 1, wherein said sheet material has advertising indicia printed directly thereon.

5. A display device according to claim 1, wherein said device is composed by one or more three-dimensional pieces.
